(19) United States
(12) Patent Application Publication
(10) Pub. No.: US 2025/0196518 A1
(43) Pub. Date: Jun. 19, 2025

(54) CONVEYING DEVICE AND RECORDING APPARATUS

(71) Applicant: CANON KABUSHIKI KAISHA, Tokyo (JP)

(72) Inventors: RYO KOBAYASHI, Kanagawa (JP); KENJI SHIMAMURA, Saitama (JP); YUJIRO ISHIDA, Tokyo (JP); TSUTOMU OBATA, Tokyo (JP)

(21) Appl. No.: 18/977,512

(22) Filed: Dec. 11, 2024

(30) Foreign Application Priority Data
Dec. 13, 2023 (JP) 2023-210548

(51) Int. Cl. B41J 15/04; B41J 11/00; B41J 11/70; B41J 15/16

(52) U.S. Cl. CPC B41J 15/046; B41J 11/0022; B41J 11/706; B41J 15/165

(57) ABSTRACT

A conveying device includes a holding portion configured to hold a rolled sheet; a conveying portion configured to convey a sheet drawn out of the rolled sheet held by the holding portion; a guide portion configured to guide the sheet conveyed by the conveying portion; and a cutting portion which is disposed in the guide portion to cut the sheet using a movable blade. The movable blade moves to a first position approaching the holding portion, and to a second position departing from the holding portion.

### BACKGROUND

### Field

The present disclosure relates to a conveying device which conveys a sheet (recording medium), and a recording apparatus which performs recording on this sheet.

### Description of the Related Art

A conventionally known recording apparatus (printer) stores a rolled sheet type recording medium, which is a long sheet wound in a roll, and records images or the like on a sheet portion drawn out of a rolled portion of the rolled sheet. In this recording apparatus, the sheet portion drawn out of the roll portion is conveyed to a recording portion, and recording is performed by ejecting recording liquid (typically ink) onto the sheet portion at the recording portion. Depending on the type of ink, fixing processing may be required so that the ink, ejected onto the sheet, is fixed to the sheet, and for this purpose, some recording apparatuses include a fixing apparatus, which dries ink using air or heat, at the downstream side of the recording portion. Further, some recording apparatuses include a cutting apparatus which cuts a sheet after recording at a predetermined position (Japanese Patent Application Publication No. 2019-162769).

In the above mentioned recording apparatus, a component that performs various processing, such as recording, fixing and cutting, on the sheet portion drawn out of the rolled portion of the rolled sheet, may be disposed to surround a housing portion of the rolled sheet, from the perspective of downsizing the device, saving space, and the like.

In other words, a conveying path for the sheet portion is formed to surround the housing portion (rolled portion of the rolled sheet), and the recording portion, the fixing portion, the cutting portion and the like are sequentially disposed along the conveying path. However, in a case of using up the rolled sheet, a new rolled sheet should be refilled in the housing portion, and a predetermined space need be created around the housing portion to perform this refilling operation.

Further, in the configuration of the recording apparatus according to Japanese Patent Application Publication No. 2019-162769, the rolled sheet (feeding roll) to supply the sheet is set on the rear face side of the recording apparatus main body, and the rolled sheet (winding roll) to collect the sheet is set on the front face side of the recording apparatus main body. In terms of operability, it is preferable for the user to perform various operations on the recording apparatus, collection operation of the recorded sheet (winding roll) and refilling operation of the rolled sheet (feeding roll) at the same standing position with respect to the device.

### SUMMARY

The present disclosure advantageously provides a technique to improve operability of the conveying device and the recording apparatus.

According to some embodiments, a conveying device of the present disclosure includes:
a holding portion configured to hold a rolled sheet;
a conveying portion configured to convey a sheet drawn out of the rolled sheet held by the holding portion;
a guide portion configured to guide the sheet conveyed by the conveying portion; and
a cutting portion which is disposed in the guide portion to cut the sheet using a movable blade, wherein
the movable blade moves to a first position approaching the holding portion and to a second position departing from the holding portion.

To achieve the above object, a recording apparatus of the present disclosure includes:
the conveying device of the present disclosure; and
a recording portion configured to perform recording on a sheet on a conveying path between the holding portion and the guide portion.

According to the present disclosure, operability of the conveying device and the recording apparatus can be improved.

Further features of the present disclosure will become apparent from the following description of exemplary embodiments with reference to the attached drawings.

### BRIEF DESCRIPTION OF THE DRAWINGS

FIGS. 1A and 1B are schematic perspective view of a recording apparatus according to Embodiment 1.

FIGS. 2A and 2B are diagrams for describing a conveying path of a sheet in the recording apparatus according to Embodiment 1.

FIG. 3 is a diagram for describing the movement of a sheet discharging portion according to Embodiment 1 of the present disclosure.

FIG. 4 is a diagram for describing the sheet discharging portion according to Embodiment 1 of the present disclosure.

FIGS. 5A and 5B are cross-sectional views at the line P of the sheet discharging portion according to Embodiment 1 of the present disclosure.

FIG. 6 is a perspective view of a cutting apparatus according to Embodiment 1 of the present disclosure.

FIG. 7 is a top view of the cutting apparatus according to Embodiment 1 of the present disclosure.

FIG. 8 is a diagram for describing details of the cutting apparatus according to Embodiment 1 of the present disclosure.

FIG. 9 is a block diagram for describing a control system according to Embodiment 1 of the present disclosure.

FIGS. 10A to 10C are diagrams for describing a fixing method of a cutting apparatus according to Embodiment 2 of the present disclosure.

FIG. 11 is a perspective view of the cutting apparatus and a paper delivery guide according to Embodiment 2 of the present disclosure.

### DESCRIPTION OF THE EMBODIMENTS

Various exemplary embodiments, features, and aspects of the present disclosure will now be described using examples, with reference to the drawings. Dimensions, materials, shapes of the components described in the embodiments and relative positions thereof may be changed in accordance with the configuration and various conditions of an apparatus to which the present disclosure is applied. In other words, the following embodiments are not intended to limit the scope of the present disclosure.

### Embodiment 1

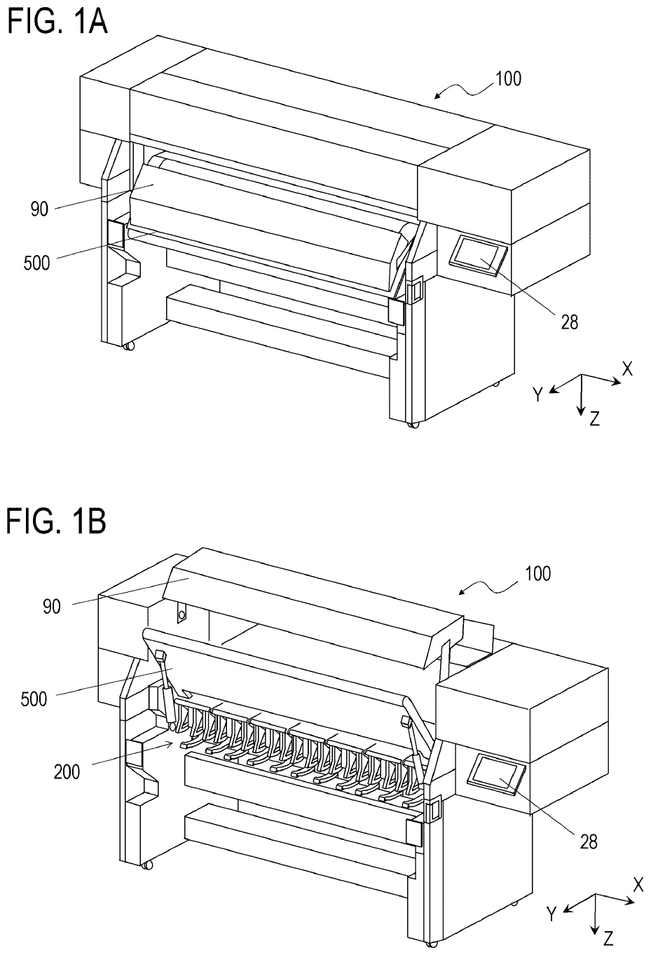

FIGS. 1A and 1B are schematic perspective views of a recording apparatus 100 according of Embodiment 1 of the present disclosure. FIG. 1A is a schematic perspective view of the recording apparatus 100 in a state where a sheet discharging portion 500 and a fixing heater 90 are closed. FIG. 1B is a schematic perspective view of the recording apparatus 100 in a state where the sheet discharging portion 500 and the fixing heater 90 are open, which is a state where a rolled sheet R is set.

The recording apparatus 100 according to Embodiment 1 is a printer configured to draw a sheet from a rolled portion, which is a rolled recording medium (recording material), and to perform recording thereon. The recording apparatus 100 according to Embodiment 1 is, for example, a recording apparatus which forms a desired recording image (text, picture, and the like) on the recording medium based on the liquid ejection recording system where liquid for recording (ink) is ejected onto the recording medium, that is, a so called “inkjet printer”.

The recording apparatus 100 according to Embodiment 1 is configured such that a full front operation is possible. In other words, in the recording apparatus 100 according to Embodiment 1, an operation panel 28 is disposed on a specific side (front face side) of the recording apparatus 100 which the user faces, so that various operations of the recording apparatus 100 and such a maintenance operation as refilling the rolled sheet R can be performed in this state.

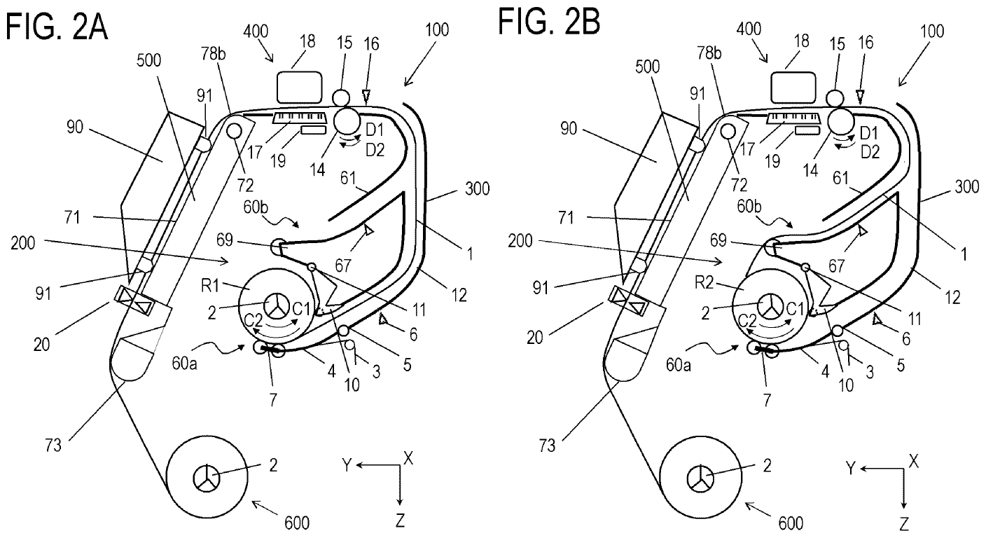

Here it is assumed that the X direction is a direction where a rotating shaft line of a spool member 2 (see FIGS. 2A, 2B, and the like) is extended holding the rolled sheet R, the Y direction is a horizontal direction orthogonal to the X direction, and the Z direction is a vertical direction (gravity direction) orthogonal to the X direction and the Y direction. The front face side of the recording apparatus 100 is one side in the Y direction, and the rear face side of the recording apparatus 100 is the other side in the Y direction. This definition of the coordinate system assumes that the normal setting state of the recording apparatus 100 is the state where the recording apparatus 100 is set on the horizontal surface.

In a feeding apparatus 200, an outward rolled sheet R1 or an inward rolled sheet R2 can be selectively set as the rolled sheet R. The outward rolled sheet R1 is a rolled sheet R which is wound such that the outer periphery side (outer side) of the rolled portion is the print surface P (recorded surface). The inward rolled sheet R2 is a rolled sheet R which is wound such that the inner periphery side (inner side) of the rolled portion is the print surface P. In the rolled sheet R, an image is printed on a sheet 1, which is a sheet portion of the rolled sheet R selectively drawn from the rolled portion. Using various switches or the like disposed on the operation panel 28, the user can input various commands and the like to the recording apparatus 100, such as specifying the size of the sheet 1 and switching between online/offline.

The recording apparatus 100 according to Embodiment 1 is configured such that the sheet discharging portion 500 (see FIGS. 2A, 2B, and the like) is movable to a shielding position where the rolled sheet R is covered (FIG. 1A), and a release position where the rolled sheet R is exposed (FIG. 1B) (details described later). The shielding position is a position of the sheet discharging portion 500 when the recording apparatus 100 performs the recording operation (first position), which is a position of the sheet discharging portion 500 approaching the rolled sheet R. The release position is a position where the sheet discharging portion 500 is distant from the rolled sheet R. The release position is a position of the sheet discharging portion 500 when the recording apparatus 100 is not performing the recording operation (second position), which is a position of the sheet discharging portion 500 positioned during a maintenance operation, such as refilling the rolled sheet R and clearing sheet jamming.

In the same manner, the recording apparatus 100 according to Embodiment 1 is configured such that the fixing heater 90 (see FIGS. 2A, 2B, and the like) is movable to a fixing position where the sheet discharging portion 500 is covered (FIG. 1A) and to a retracting position (FIG. 1B) (details will be described later). The fixing position is a position of the fixing heater 90 facing the sheet discharging portion 500. The fixing position is a position where the fixing heater 90 as a fixing portion faces the sheet discharging portion 500 (third position) when the recording apparatus 100 performs the recording operation, and is a position where the fixing processing is performed on a portion of the sheet 1 conveyed through the sheet discharging portion 500. The retracting position is a position of the fixing heater 90 located when the recording apparatus 100 is not performing the recording operation (fourth position), which is a position where the fixing heater 90 is distant from the sheet discharging portion 500, so that the sheet discharging portion 500 can be positioned at the release position mentioned above.

FIGS. 2A and 2B are schematic cross-sectional views of key portions of the recording apparatus 100. FIG. 2A is a schematic cross-sectional view indicating a state of conveying a sheet when the outward rolled sheet R1 is set. FIG. 2B is a schematic cross-sectional view indicating a state of conveying a sheet when the inward rolled sheet R2 is set.

As indicated in FIGS. 2A and 2B, the recording apparatus 100 includes a feeding apparatus 200, a sheet conveying portion 300, a recording portion 400, the sheet discharging portion 500, and a winding portion 600. In the recording apparatus 100 according to Embodiment 1, a component mainly related to conveying the sheet corresponds to the conveying device of the present disclosure.

The feeding apparatus 200 holds a rolled sheet R as the holding portion, and feeds a sheet 1, which is a sheet portion of the rolled sheet R drawn from the rolled portion, to a conveying path. The sheet conveying portion 300 forms the conveying path of the sheet 1, from the feeding apparatus 200 to the recording portion 400, and provides a conveying force to move the sheet 1 on the conveying path using a conveying roller disposed on the conveying path. The recording portion 400 performs recording on the sheet 1 by ejecting ink onto a recording surface of the sheet 1 in a portion conveyed by the sheet conveying portion 300 in the sheet 1. The sheet discharging portion 500 is a guide portion which guides the portion (recorded portion) of the sheet 1 recorded by the recording portion 400, along the conveying path. The winding portion 600 winds up a portion of the sheet 1 guided by the sheet discharging portion 500.

The fixing heater 90 is disposed in the sheet discharging portion 500. The fixing heater 90 is configured as a heater type fixing portion, which performs the fixing processing on a part of the sheet 1 passing through the sheet discharging portion 500 by applying hot air to heat and dry the ink. The fixing portion may be configured such that ink having the nature to be cured by UV light (ultraviolet light) is used as the liquid for recording, and UV light is emitted to perform fixing by curing the ink.

A cutting apparatus 20, which is a cutting portion, is disposed between the sheet discharging portion 500 and the winding portion 600 on the conveying path of the sheet 1. The cutting apparatus 20 can cut a predetermined length of region of the sheet 1, including a portion wound by the winding portion 600 (recorded portion), from the rest of the sheet 1 connected to the rolled portion, and collects it as an output of the recording apparatus 100.

The configuration to collect the recorded sheet 1 is not limited to the configuration of winding the sheet 1 of Embodiment 1, but may be a configuration of cutting the sheet 1 by the cutting apparatus 20, and receiving and holding the sheet 1 that is dropped into a basket or the like, for example.

Each portion of the sheet conveying portion 300, the recording portion 400, the sheet discharging portion 500, and the winding portion 600 are disposed so as to surround the feeding apparatus 200. In other words, the conveying path of the sheet 1, which is a sheet portion drawn from the rolled portion of the rolled sheet R, is a path sequentially passing around the feeding apparatus 200 via the sheet conveying portion 300, the recording portion 400, the sheet discharging portion 500, and the winding portion 600.

Each portion of the recording apparatus 100 will now be described in detail.

FIG. 2A indicates a state of conveying a sheet when an outward rolled sheet R1 is set. In the feeding apparatus 200 disposed in a vertically lower portion of the recording apparatus 100, two sheet feeding portions 60a and 60b are disposed corresponding to the rolled sheets R1 and R2 respectively. An oscillating member 7, which includes two rollers, and an outward rolled sheet arm member 4 are integrated vertically below the outward rolled sheet R1, so that the outward rolled sheet R1 can rotate around an outward rolled sheet arm rotating shaft 5. An outward rolled sheet arm spring member 3 is disposed so as to pressure the integrated unit of the outward rolled sheet arm member 4 and the oscillating member 7 in a direction toward the center of the rolled sheet, whereby the two rollers of the oscillating member 7 are constantly in pressure-contact with the rolled sheet R1. In the state of pressing the integrated unit of the outward rolled sheet arm member 4 and the oscillating member 7 to the rolled sheet R1, the rolled sheet R1 that is set is rotated in the C1 direction by driving the rolled sheet (not illustrated). Thereby a frictional force is generated between the rollers of the oscillating member 7 and the rolled sheet R1, and the sheet 1 drawn out from the rolled sheet R1 can be conveyed to the conveying roller 14 via a conveying path, which is formed by an outward rolled sheet conveying guide 12 of the sheet conveying portion 300. An outward rolled sheet detection sensor 6 is disposed in the outward rolled sheet conveying guide 12.

An outward rolled sheet separation flapper 10 is disposed between the rolled sheet R1 and an upper part of the feeding port of the outward rolled sheet feeding portion 60, and is constantly in pressure contact with the rolled sheet R1 by its own weight. Because of the function of the outward rolled sheet separation flapper 10, the front end of the sheet 1 is separated from the rolled portion of the rolled sheet R1 when the rolled sheet R1 rotates, and the sheet 1 can be easily fed to the feeding port of the outward rolled sheet feeding portion 60a.

FIG. 2B indicates a state of conveying a sheet when an inward rolled sheet R2 is set.

Unlike the outward rolled sheet R1, the inward rolled sheet R2 has a configuration such that the front end of the sheet 1 cannot be automatically conveyed to the conveying roller 14 of the conveying path of the sheet conveying portion 300, hence the user must convey the front end of the sheet 1 manually.

The user separates the front end of the sheet 1 from the rolled portion of the rolled sheet R2, and places it on an inward rolled sheet manual feeding guide 69. Then the user manually feeds the sheet 1 on the inward rolled sheet manual feeding guide 69 toward the downstream side, whereby the front end of the sheet 1, drawn from the rolled sheet R2, reaches the conveying roller 14 via the conveying path of the sheet conveying portion 300. An inward rolled sheet detection sensor 67 is disposed on the conveying path of the sheet 1, which is drawn from the inward rolled sheet R2.

Both the sheet 1 drawn from the outward rolled sheet R1 and the sheet 1 drawn from the inward rolled sheet R2 can be drawn to the downstream side of the sheet conveying portion 300 when the paper is detected by a second sheet sensor 16 (paper detection: ON), by the conveying roller 14 rotating in the feeding direction. Then the sheet 1 is conveyed to the recording portion 400.

The recording portion 400 includes an inkjet print head 18 (hereafter “recording head 18”), and can print (record) an image on the sheet 1 by ejecting liquid for recording (ink) from the recording head 18. The recording head 18 includes an ejection energy generation element, such as an electro-thermal conversion element (heater) and a piezoelectric element. The recording head 18 is configured to eject ink from ejection ports using energy generated by the ejection energy generation element. In the case of using the electro-thermal conversion element, the ink is foamed by this heating, and ink can be ejected from the ejection ports using this foaming energy.

The recording head 18 is not limited to an inkjet type, and a print type of the recording portion 400 is also not limited, and a serial scan type or full line type, for example, may be used. In the case of the serial scan type, an image is printed using the conveying operation of the sheet 1, and scanning with the recording head 18 in the direction crossing the conveying direction of the sheet 1. In the case of the full line type, an image is printed while conveying the sheet 1 consecutively, using a long recording head 18, which extends in the direction crossing the conveying direction of the sheet 1.

The fixing heater 90 disposed above the sheet discharging portion 500 can fix the ejected ink on the sheet 1 (recording medium) by blowing warm air onto the sheet 1, which is drawn from the recording portion 400 and is supported by a paper delivery guide 71. Fixing heater landing members 91 are disposed at four corners of the surface of the fixing heater 90 where warm air is blown, so as to land on the paper passing surface of the paper delivery guide 71. Thereby a gap is created between the surface of the fixing heater 90 where warm air is blown and the sheet conveying surface of the paper delivery guide 71. The fixing heater 90 is installed on an apparatus main body of the recording apparatus 100 via a link mechanism, and can be retracted to the upper portion of the apparatus main body of the recording apparatus 100.

The fixing heater 90 here is a component having a function to dry and fix the ink ejected onto the sheet 1 to the sheet 1 by heat and air. Therefore, in a recording apparatus using ink which is quickly fixed after ejection (e.g. water based ink) as the liquid for recording, the fixing heater 90 may not be disposed.

The paper delivery guide 71 disposed in the sheet discharging portion 500 is a guide member, which forms a conveying surface for the sheet 1 drawn from the recording portion 400, and guides the sheet 1 that is discharged out of the recording apparatus 100 while supporting the rear face (non-recording surface) of the sheet 1. The paper delivery guide 71 integrally includes a cutting apparatus 20 and a paper delivery guide downstream R portion 73 at the downstream side of the sheet conveying path, whereby the rolled sheet R, of which fixing is completed, can be cut.

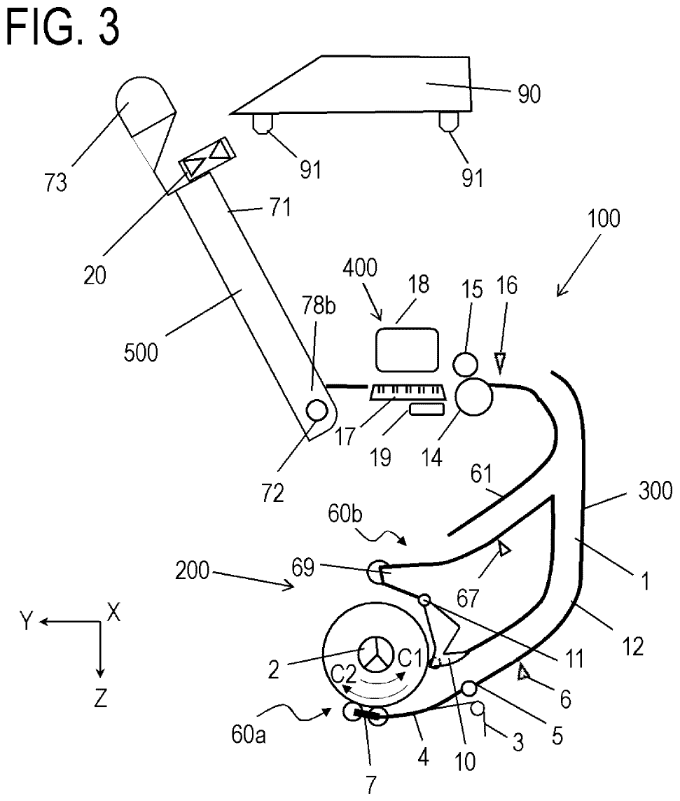

FIG. 3 is a schematic cross-sectional view when the sheet discharging portion 500 is moved such that the rolled sheet R (feeding apparatus 200) is exposed to the outside of the recording apparatus 100. The sheet discharging portion 500 is configured so as to be rotatable around the paper delivery guide rotating shaft 72. The fixing heater 90 is configured to be elevatable by a link mechanism with respect to the apparatus main body, so as to be retracted to the outer side of the movable regions of the sheet discharging portion 500 and the cutting apparatus 20.

In the case of the configuration where the sheet discharging portion 500 is fixed to the apparatus main body, a possible way of accessing the rolled sheet R is, for example, creating a space below the sheet discharging portion 500, or accessing from the rear face side of the apparatus on the opposite side of the sheet discharging portion 500. In the former case, the rolled sheet R must be disposed below the sheet discharging portion 500 such that both the rolled sheet (feeding roll) and the recorded sheet (winding roll) must be independently accessed, therefore the apparatus size, especially the size in the height direction, may be increased. In the latter case, the operation to refill the rolled sheet (feeding roll) and the operation to collect the recorded sheet (winding roll) are performed on the different sides of the apparatus main body, therefore operability of the apparatus can be diminished.

The recording apparatus 100 of Embodiment 1 is a printer where the feeding apparatus 200 and the winding portion 600 are accessible from the front face side of the recording apparatus 100 (that is, the front operation is possible) by retracting the sheet discharging portion 500 and the cutting apparatus 20, as mentioned above. In other words, by rotating and retracting the sheet discharging portion 500, the space to perform the operation to set the feeding rolled sheet R below the sheet discharging portion 500 (position of the sheet discharging portion 500 before retraction) can be secured. Hence the feeding apparatus 200 and the sheet discharging portion 500 can be disposed at approximately the same height, and the size of the main body of the recording apparatus 100 can be decreased. Further, the operation to refill the rolled sheet (feeding roll) and the operation to collect the recorded sheet (winding roll) can be performed on the same side of the apparatus main body, which improves operability of the apparatus.

In the above description of Embodiment 1, the driving mechanism to retract the sheet discharging portion 500 rotates the sheet discharging portion 500 around the paper delivery guide rotating shaft 72, but instead of rotation, the sheet discharging portion 500 may be elevated along a linear moving path using a link mechanism or the like.

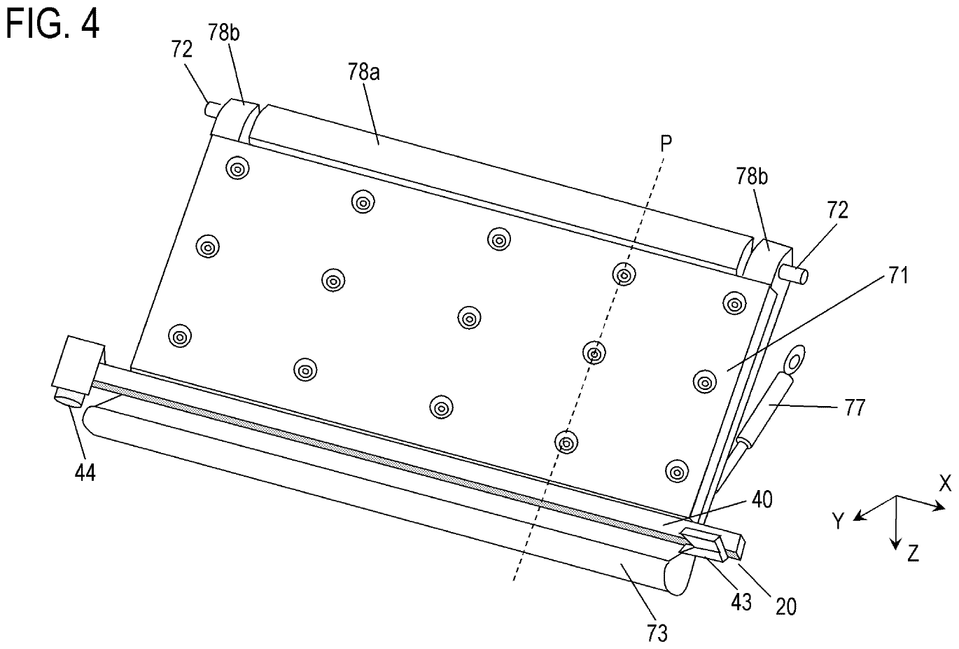

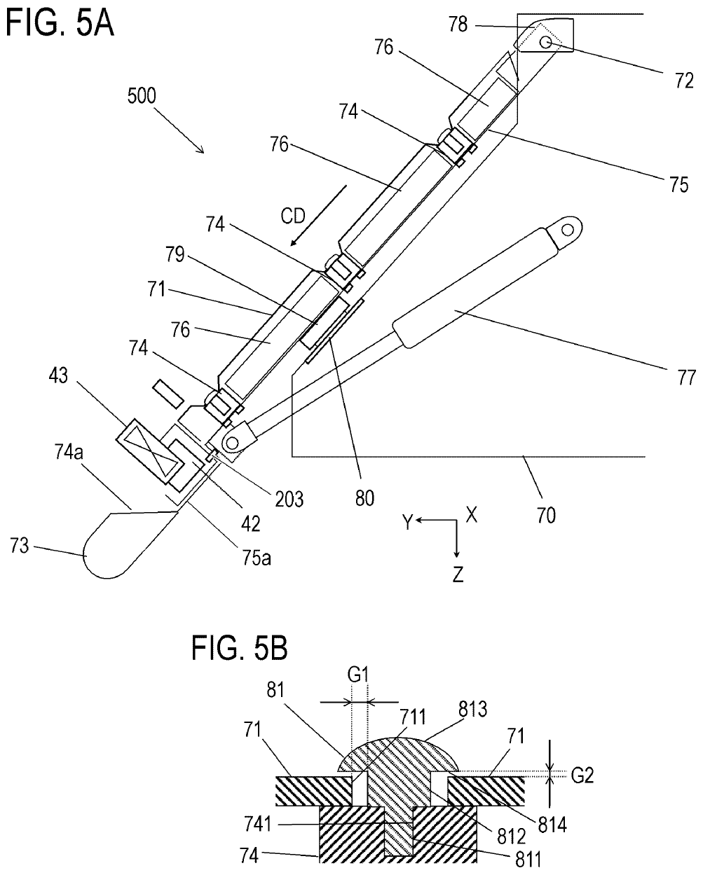

The configuration around the sheet discharging portion 500 and the cutting apparatus 20 will now be described in detail with reference to FIGS. 4, 5A, and 5B. FIG. 4 is a schematic perspective view of the sheet discharging portion 500. FIG. 5A is a schematic cross-sectional view (cross-sectional view at the P line in FIG. 4) of the sheet discharging portion 500. FIG. 5B is a schematic cross-sectional view for describing the configuration of a fixing portion of the paper delivery guide 71 and a fixing member 74.

The sheet discharging portion 500 has a role of guiding the sheet 1, with supporting the rear face of the sheet 1 drawn from the recording portion 400, so that the sheet 1 is discharged out of the recording apparatus 100. The outer shape of the sheet discharging portion 500 is constituted of the paper delivery guide 71 which supports the rear face of the sheet 1 and a paper delivery guide base 75 which is connected with the paper delivery guide 71. The paper delivery guide base 75, which is a base member, is disposed on the opposite side of the conveying path of the sheet 1 with respect to the paper delivery guide 71. The paper delivery guide 71 and the paper delivery guide base 75 are connected with each other so as to integrally form a box shape, whereby the rigidity of the sheet discharging portion 500 as a whole is ensured.

The paper delivery guide 71 is heated directly, or via the sheet 1, by the warm air from the fixing heater 90, and in the fixing and drying step, the paper delivery guide 71 also has a function to accelerate the fixing and drying by heating the sheet 1 from the rear face side. Therefore, the paper delivery guide 71 is required to have heat resistance and high thermal conductivity to prevent temperature unevenness, and a steel plate, SUS material, an aluminum plate, or the like is used as a material of the paper delivery guide 71. In the following description, it is assumed that a metal plate is used. However, in a case of using ink which is quickly fixed and dried after ejection (e.g. water based ink), the fixing heater 90 is unnecessary, and the thermal conductivity need not be very high, hence the paper delivery guide 71 may be formed of resin, or the like.

The paper delivery guide 71 and the paper delivery guide base 75 are connected using the paper delivery guide fixing member 74 (hereafter “fixing member 74”). The fixing member 74 has a hook on one side of the paper delivery guide 71 in the vertical direction with respect to the sheet support surface, and is secured to the paper delivery guide base 75 by hooking to the paper delivery guide base 75. The fixing member 74 has a screw hole on the other side in the vertical direction, and is fixed to the paper delivery guide 71 using a screw.

In the paper delivery guide 71, a drawing shape is formed so as to be concaved from the support surface of the sheet 1, and the positions of the drawing shape and the fixing member 74 are matched so that the screw head of the screw used for fixing is set at the depth of the drawing shape or less, without sticking out toward the sheet support surface. Thereby the fixing member 74 does not affect the paper passing performance of the sheet 1. It is preferable to dispose the drawing shape to not match with the edge of the sheet width of a standard sized sheet, in order to prevent the risk of hooking of the front end or rear end of the sheet 1.

A heat insulating material 76 is filled in the space between the paper delivery guide 71 and the paper delivery guide base 75. Thereby transfer of the heat from the paper delivery guide 71 to the paper delivery guide base 75 is prevented.

As illustrated in FIG. 5B, the paper delivery guide 71 and the fixing member 74 are fixed by a shoulder screw 81. The shoulder screw 81 has a threaded portion 811, a shank portion 812 and a head portion 813. The threaded portion 811 is configured to be screwed into a screw hole 741 of the fixing member 74. The shank portion 812 has a larger diameter than the threaded portion 811, and protrudes from the head portion 813, and the threaded portion 811 is coaxially disposed on the front end side. The head portion 813 is a flange shaped portion having a larger diameter than the shank portion 812, and in Embodiment 1, the head portion 813 is a truss head or a round cup head. The threaded portion 811 and the shank portion 812 of the shoulder screw 81 are inserted into a fixing hole 711 of the paper delivery guide 71, in a direction vertical to the sheet support surface of the paper delivery guide 71, and the threaded portion 811 is screwed into the screw hole 741 of the fixing member 74, whereby the paper delivery guide 71 is fixed to the fixing member 74.

The shank portion 812 is a first regulating portion to regulate a range of relative movement that is allowed between the paper delivery guide 71 and the fixing member 74 in a direction parallel with the sheet support surface of the paper delivery guide 71. The shank portion 812 is formed to have a smaller diameter than the fixing hole 711, so that about a 1 millimeter (mm) gap G1, to allow the sliding of the paper delivery guide 71 (relative movement with respect to the fixing member 74), is formed from the fixing hole 711 in the direction parallel with the sheet support surface of the paper delivery guide 71.

The head portion 813 has a regulating surface 814 that faces the fixing member 74 and the paper delivery guide 71, so that the paper delivery guide 71 is held between the head portion 813 and the fixing member 74 in the direction vertical to the sheet support surface of the paper delivery guide 71. The regulating surface 814 is a second regulating portion to regulate a range of relative movement that is allowed between the paper delivery guide 71 and the fixing member 74 in a direction vertical to the sheet support surface of the paper delivery guide 71. The regulating surface 814 is formed to have about a 0.1 mm gap G2, to allow the sliding of the paper delivery guide 71 (relative movement with respect to the fixing member 74), that is, not to completely fix the paper delivery guide 71 in the direction vertical to the sheet support surface.

As described above, the paper delivery guide 71 and the fixing member 74 are not completely fixed due to the fixing using the shoulder screw 81, and a small gap exists in the direction vertical to the sheet support surface. Thereby, even if thermal expansion is generated in the paper delivery guide 71 in the direction parallel with the sheet support surface by the fixing heater 90 heating the paper delivery guide 71, the positional deviation of the fixing portion caused by the thermal expansion is cancelled since the paper delivery guide 71 slides with respect to the fixing member 74. By this sliding of the paper delivery guide 71, deformation of the paper delivery guide 71 in the direction vertical to the sheet support surface can be prevented.

In the above mentioned fixing configuration using the shoulder screw, the dispersion of the gap between the paper delivery guide 71 and the sheet conveying surface of the fixing heater 90 from which warm air is blown may increase due to the component tolerance. The gap influences the fixability considerably, and if the gap is too wide, heat cannot be transferred well, which causes insufficient fixing, and if the gap is too narrow, a wind ripple pattern or the like may be generated by the blowing of the warm air. Hence in the case where high precision is demanded for the gap dimension, the sheet conveying surfaces of the paper delivery guide 71 and the fixing heater 90 may be assembled after adjusting the flatness respectively.

The heat of the paper delivery guide 71, heated by the fixing processing, is not transferred to the paper delivery guide base 75 because of the heat insulating material 76 that exists between the paper delivery guide 71 and the paper delivery guide base 75. Further, suppressing the transfer of heat from the paper delivery guide 71 to the other components prevents cooling of heat in the gap between the fixing heater 90 and the paper delivery guide 71, that is, fixing performance can be ensured without wasting power.

The cutting apparatus 20 is installed to the paper delivery guide base 75 using screws or the like at the downstream side of the paper delivery guide 71 on the sheet conveying path. The configuration of the cutting apparatus 20 will be described in detail later. In Embodiment 1, the cutting apparatus 20 is configured to cut the sheet 1 by moving a cutter unit 43 in the sheet width direction (X direction) which is orthogonal to the sheet conveying direction CD. This means that in a region where the cutter unit 43 passes, a groove, that is recessed from the sheet conveying surface, is formed on the sheet conveying path, and there is concern that the conveying performance of the sheet 1 will be affected. Therefore, in the configuration of Embodiment 1, at the downstream side edge of the paper delivery guide base 75, a diagonally bent portion (inclined path 74a) is added to the downstream side of the cutting apparatus 20. The paper delivery guide base 75 has a concaved portion 75a, where the cutting apparatus 20 is installed, at the downstream side edge of the conveying path. The concaved portion 75a is concaved from the sheet conveying surface formed by the paper delivery guide 71. The inclined path 74a is formed at the downstream side edge of the concaved portion 75a of the conveying path, and forms an inclined surface which extends, with inclining upward from the height of the base portion of the concaved portion 75a to the height that is the same as the sheet conveying surface of the paper delivery guide 71, in the direction from the upstream to the downstream of the conveying path. By including this inclined path 74a, the sheet 1 is conveyed to the downstream side without the front end of the sheet 1 getting hooked, even if the front end of the sheet 1 falls into the above mentioned groove portion while being conveyed.

At the downstream side of the inclined path 74a, a paper delivery guide downstream R portion 73 is disposed as a downstream guide portion. The paper delivery guide downstream R portion 73 is a part which actively contacts with the sheet 1 when the sheet 1, of which fixing is completed, is wound up in the winding portion 600. The paper delivery guide downstream R portion 73 contacts with the sheet 1, so as to apply tensile force to the sheet 1, and guides the sheet 1 between the sheet discharging portion 500 (paper delivery guide 71) and the winding portion 600 on the conveying path of the sheet 1.

The paper delivery guide downstream R portion 73 is configured such that the cross section, vertical to the width direction of the sheet 1 crossing with the conveying direction CD of the sheet 1, has an R shape (arc shape). If this part was square shaped in the cross section, the fixed sheet 1 may be bent or wrinkled. The paper delivery guide downstream R portion 73 of Embodiment 1 having an arc-shaped cross section can minimize damage to the sheet 1.

In the same manner, a paper delivery guide upstream main body R portion 78a and a paper delivery guide upstream R portion 78b preferably have an arc-shaped cross section, instead of a square-shaped cross section, since these are also located between a platen 17 and the paper delivery guide 71 and are portions where the sheet 1 is in active contact. It is preferable that the paper delivery guide upstream main body R portion 78a and the paper delivery guide upstream R portion 78b are disposed coaxially, with the rotating shaft line of the paper delivery guide rotating shaft 72 as the respective center of the rotation, and have the same R dimension (radius of curvature of the arc-shaped portion).

The paper delivery guide upstream main body R portion 78a is attached to the apparatus main body of the recording apparatus 100, and is disposed to not interfere with the rotation of the sheet discharging portion 500. The paper delivery guide upstream R portion 78b, on the other hand, is integrated with the sheet discharging portion 500, and integrally rotates with the sheet discharging portion 500 when the sheet discharging portion 500 rotates. Because of this configuration, a space is created between the paper delivery guide 71 and the paper delivery guide upstream main body R portion 78a when the sheet discharging portion 500 is opened to set the rolled sheet R in the main body, and the platen 17 can be viewed from the front face of the recording apparatus 100. As mentioned above, when the inward rolled sheet R2 is fed, the sheet 1 is fed manually, hence it is necessary to confirm whether the front end of the sheet 1 reached the conveying roller 14, and creating this space makes it easier to feed and set the sheet.

The sheet discharging portion 500 can be rotated around the paper delivery guide rotating shaft 72, and is rotated when the rolled sheet R is set in the apparatus main body of the recording apparatus 100. The paper delivery guide rotating shaft 72 is installed on a main body side panel 70 of the recording apparatus 100, and a member having low sliding resistance, such as a bearing, is used for the rotating portion. A gas spring 77 is installed in the lateral direction on the lower side of the sheet discharging portion 500. The gas spring 77 is installed such that one end thereof is fixed to the rear side of the sheet discharging portion 500 at the downstream side, and the other end is fixed to the main body side panel 70 respectively. The gas spring 77 is expandable, and its force is always applied in the expanding direction. Therefore, as the gas spring 77 is installed as illustrated in FIGS. 4, 5A, and 5B, a component of the force in the expanding direction of the gas spring 77 acts in the direction of opening the sheet discharging portion 500, whereby the sheet discharging portion 500 can be opened with a light force.

The reaction force setting of the gas spring 77 will be described next. When the rolled sheet R is set in the main body of the recording apparatus 100, the sheet discharging portion 500 should be kept in an open state. Hence the reaction force of the gas spring 77 is set to be a force larger than the force of the closing sheet discharging portion 500 by its own weight. However, when the reaction force to keep the sheet discharging portion 500 in the open state is too strong, it may become difficult to keep the sheet discharging portion 500 in a closed state, and in some cases, the sheet discharging portion 500 may open naturally. Therefore, a holding member 79 is installed in the paper delivery guide base 75, and a landing portion 80, formed by bending, is disposed on the main body side panel 70, located on the opposite side when the sheet discharging portion 500 is closed. The holding member 79 here is formed of a magnet, and is attracted to the main body side panel 70 by a magnetic force. The magnetic force of the magnet of the holding member 79 is set to have a holding force that is larger than the force to open the sheet discharging portion 500 by the gas spring 77. Thereby the state of closing the sheet discharging portion 500 can be maintained.

In some cases, depending on the configuration of the sheet discharging portion 500 and the recording apparatus 100, there is not concern about the above mentioned problem of the sheet discharging portion 500 opens automatically without being maintained in the closed state. In other words, depending on the weight and the center of gravity of the sheet discharging portion 500 and the position of the gas spring 77, the sheet discharging portion 500 can be maintained in the state opened by the gas spring 77, and can maintain the closed state by its own weight of the sheet discharging portion 500. Further, in the configuration described above, the gas spring 77 is installed on the basis of the assumption that the printer is a large printer, but in a case of a recording apparatus supporting only a small sheet width, the weight of the sheet discharging portion 500 is light, and the gas spring 77 may be omitted if unnecessary.

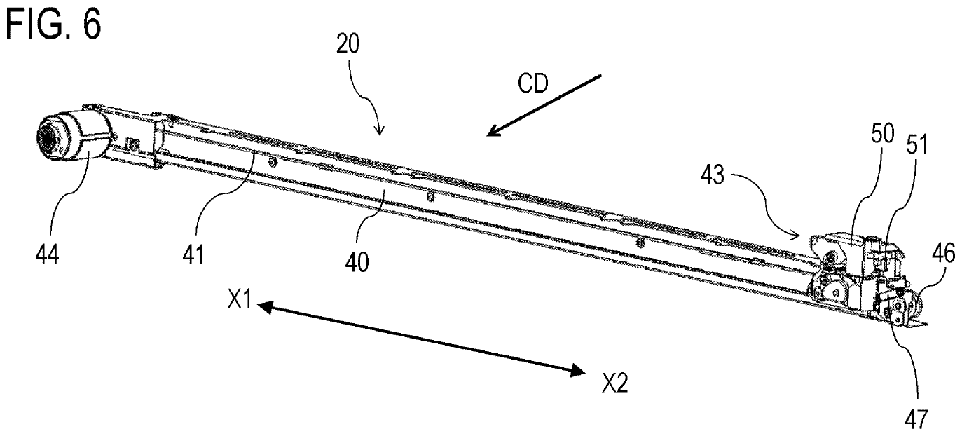

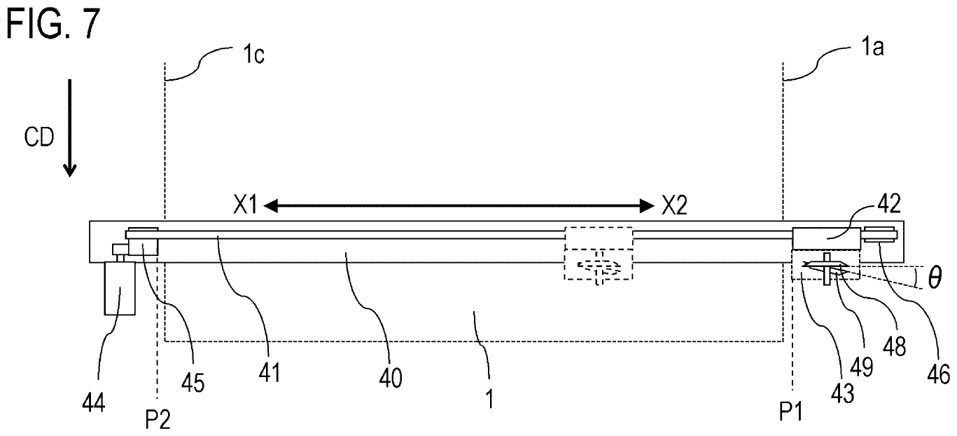

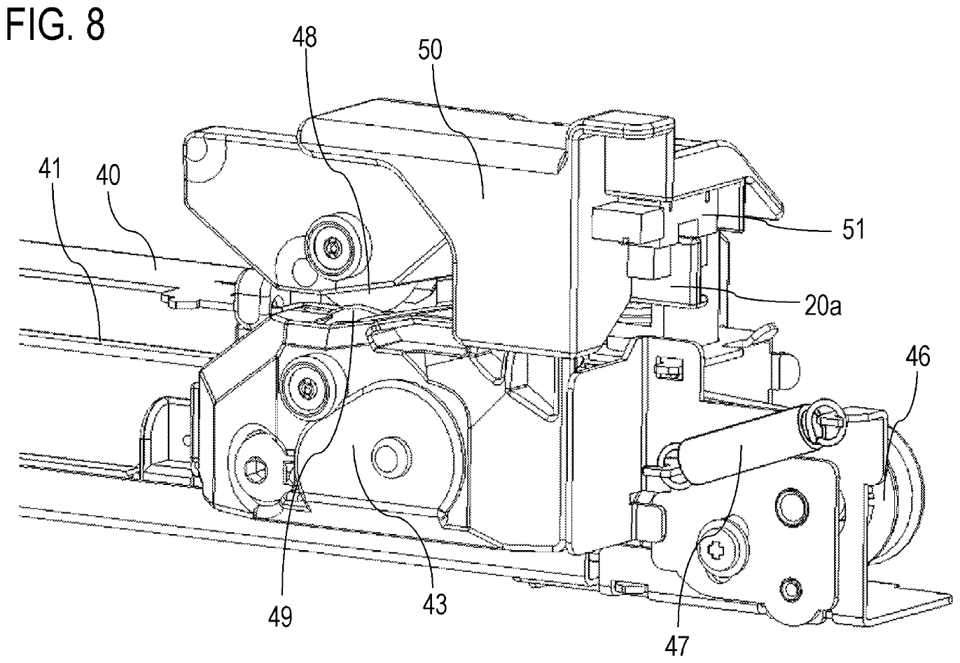

The cutting apparatus 20 according to Embodiment 1 will be described with reference to FIGS. 6, 7 and 8.

The cutting apparatus 20 includes a cutter rail 40, a cutter belt 41, a cutter carriage 42 and the cutter unit 43. The cutter rail 40 is configured to guide the cutter carriage 42 in the width direction of the sheet 1, which is orthogonal to the conveying direction CD of the sheet 1. The cutter unit 43 and the cutter belt 41 are integrally connected respectively to the cutter carriage 42. A cutter motor 44 and a motor pulley 45 are disposed near one end of the cutter rail 40 in the sheet width direction, and a tensioner pulley 46 and a tensioner spring 47 are disposed on the other end thereof. The cutter belt 41 is passed around the motor pulley 45 and the tensioner pulley 46, and tooth skipping of the cutter belt 41 is prevented by tensioner pulley 46 in the X2 direction using the tensioner spring 47. The cutter rail 40 of the cutting apparatus 20 is fixed to the paper delivery guide base 75, and by removing screws, the cutting apparatus 20 can be detached from the paper delivery guide base 75 for replacement.

As cutting members, the cutter unit 43 includes an upper movable blade 48 (upper blade) and a lower movable blade 49 (lower blade), which are disposed in a direction vertical to the surface of the sheet 1. The upper movable blade 48 and the lower movable blade 49 have contact portions respectively, and cut the sheet 1 at these contact portions by holding the sheet 1 between these contact portions and moving on the guide rail along the width direction of the sheet in this state. Specifically, the upper movable blade 48 and the lower movable blade 49 are disposed to contact each other forming a predetermined angle θ (crossing angle) with respect to the cutting direction X1, and the sheet 1 is cut by the contact portion of the upper movable blade 48 and the lower movable blade 49.

The cutter carriage 42 can move back and forth in the X1 and X2 directions along the cutter rail 40 by the driving force transferred from the cutter motor 44 via the cutter belt 41. The cutter unit 43, which is connected to the cutter carriage 42, can also move back and forth in the X1 and X2 directions, in the same manner as the cutter carriage 42.

The lower movable blade 49 can be rotary-driven by the cutter motor 44 via the cutter belt 41 and the cutter carriage 42. Thereby when the sheet 1 is cut, the lower movable blade 49 and the upper movable blade 48, which is in contact with the lower movable blade 49, rotate together to cut the sheet 1.

When an image is recorded on the sheet 1, the cutter unit 43 stands by at a standby position P1, which is retracted from the paper end 1a of the sheet 1 on the home position side. When the sheet 1 is cut, the cutter unit 43 cuts the sheet 1 by the contact portion of the upper movable blade 48 and the lower movable blade 49, moving from the standby position P1 in the X1 direction (cutting direction) until the cutter unit 43 passes the paper end 1c on the opposite side of the home position. After the sheet 1 is cut, the cutter unit 43 is inverted at an inversion position P2 corresponding to the width of the sheet 1, and moves in the X2 direction (return direction) which does not contribute to the cutting operation. Whereby the cutter unit 43 moves to the standby position P1 and stands by for the next cutting operation.

The cutter motor 44 includes an encoder, so as to control the moving position of the cutter unit 43 in the X1 direction and the X2 direction. Since the relationship of the number of pulses of the encoder and the moving distance of the cutter unit 43 is known, the moving distance of the cutter unit 43 can be determined by counting the number of pulses of the encoder. The cutter motor 44 includes a standby position sensor 51 disposed near the standby position P1 in a part of the sensor holder 50 that is fixed, so that a sensor flag portion 20a, disposed in the cutter unit 43, is detected by the standby position sensor 51, and the cutter unit 43 is accurately stopped at the standby position P1. The standby position sensor 51 can also detect whether or not the cutter unit 43 is present at the standby position P1.

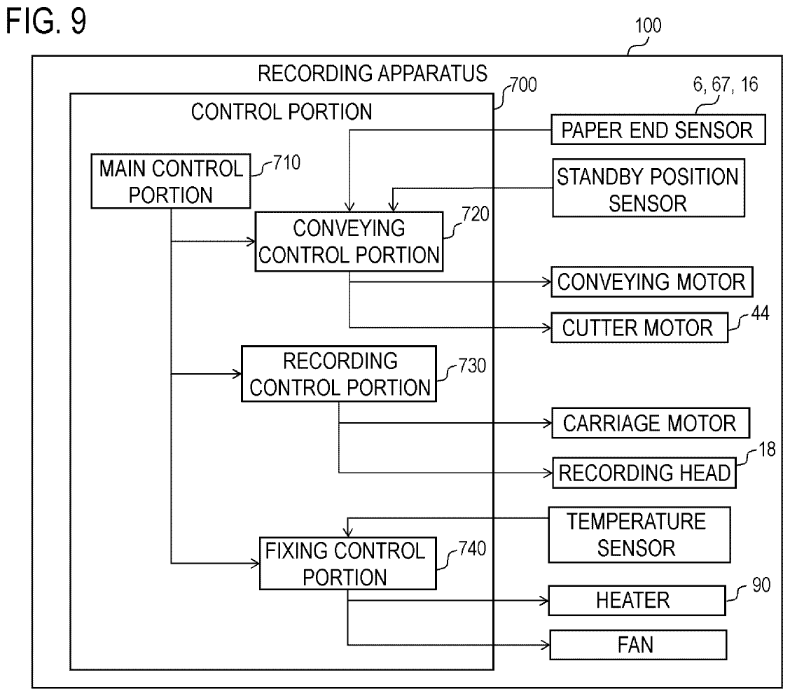

A control configuration of the recording apparatus 100 according to Embodiment 1 will be described with reference to FIG. 9. FIG. 9 is a block diagram for describing the control configuration of Embodiment 1.

The control portion 700 includes a CPU, a ROM, a RAM, a motor driver, and the like (not illustrated), and is constituted of a main control portion 710, a conveying control portion 720, a recording control portion 730, and a fixing control portion 740. The main control portion 710 sends instructions to the conveying control portion 720, the recording control portion 730, and the fixing control portion 740. On the basis of the determination by the main control portion 710, the conveying control portion 720 drives the conveying motor and conveys the sheet 1 to an arbitrary position, while checking the position of the sheet 1 using a paper end sensor (not illustrated), then drives the cutter motor 44 and cuts the sheet 1. The recording control portion 730 forms a recording image at a predetermined position using the linkage of a carriage motor (not illustrated) and the recording head 18. According to the control program stored in the ROM, the fixing control portion 740 adjusts the air capacity of a fan (not illustrated), which is included in the fixing heater 90, and the temperature of the heater, and fixes the ink thereby.

### Embodiment 2

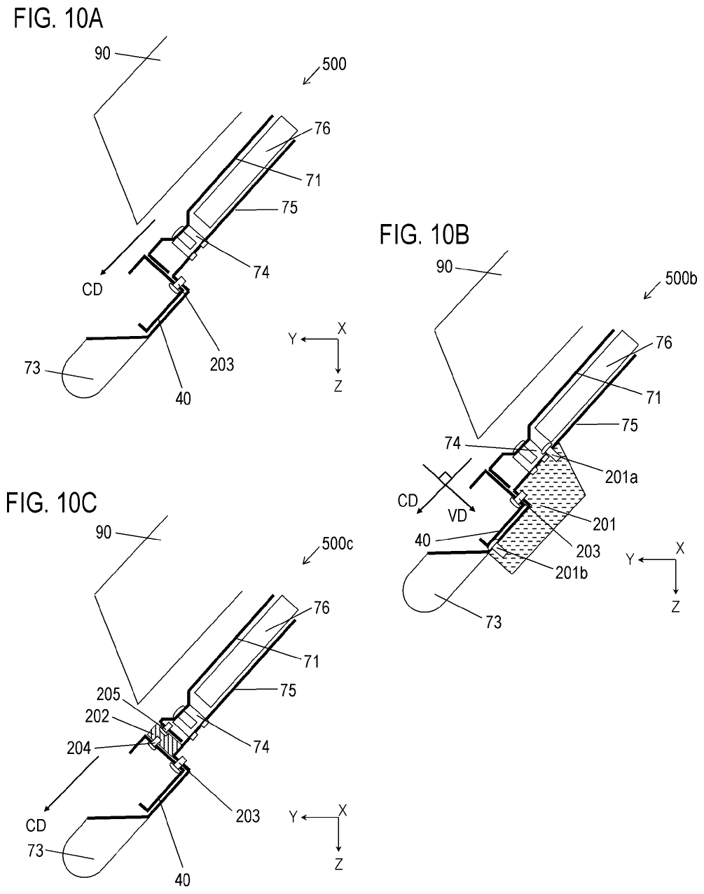

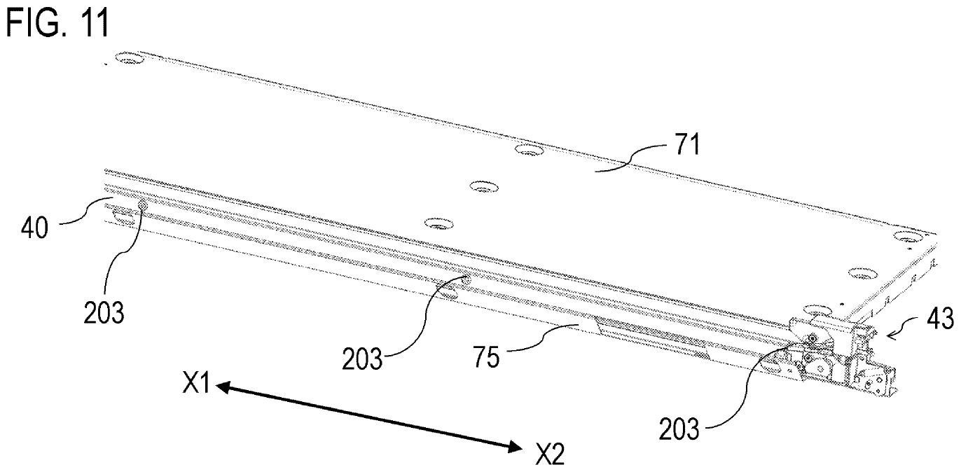

A recording apparatus according to Embodiment 2 will be described with reference to FIGS. 10A to 10C and FIG. 11. Here the configuration around the fixing portion of the cutting apparatus 20 according to Embodiment 2 will be described. FIG. 10A is a schematic cross-sectional view of a downstream side configuration of the sheet discharging portion 500 according to Embodiment 1. FIG. 10B is a schematic cross-sectional view of a downstream side configuration of a sheet discharging portion 500b according to Embodiment 2. FIG. 10C is a schematic cross-sectional view of a downstream side configuration of a sheet discharging portion 500c according to a modification of Embodiment 2. FIG. 11 is a schematic perspective view of a downstream side configuration of the sheet discharging portion 500. In FIGS. 10A to 10C, illustration of the cutter belt 41, the cutter carriage 42, the cutter unit 43 and the like is omitted.

In Embodiment 2, a composing element the same as Embodiment 1 is denoted with the same reference sign as Embodiment 1, and description thereof is omitted. Matters that are not described in Embodiment 2 are the same as Embodiment 1.

In FIG. 10A, the fixing heater 90 is disposed above the paper delivery guide 71. During the fixing and drying operation, high temperature hot air is blown from the fixing heater 90 toward the sheet 1 and the paper delivery guide 71, and the space between the paper delivery guide 71 and the fixing heater 90 may reach a temperature equal to or higher than 100° C. The cutting apparatus 20, disposed at the immediate downstream side of the fixing and drying region, is located at a position to which heat is easily transferred.

The cutting apparatus 20 has a configuration where the rigidity thereof in the longitudinal direction (sheet width direction) is ensured by the strength of the cutter rail 40, and such components as the cutter belt 41, the cutter carriage 42 and the cutter unit 43 are installed. In order to ensure the strength of the cutter rail 40, a metal material (e.g. steel plate) is used, and in order to secure the cutting apparatus 20, the cutter rail 40 is screwed to each of a plurality of fixing portions 203, which are disposed in the paper delivery guide base 75 in the sheet width direction, as illustrated in FIG. 11. However, the heat from the fixing heater 90 may be transferred to the cutter belt 41, the cutter carriage 42 and the cutter unit 43 via the cutter rail 40 (metal material), and these components may reach a high temperature. In such a case, deformation of or damage to the components, teeth skipping of the belt, and other problems may be generated depending on the load applied to cut the sheet 1. Therefore, it is preferable that the cutter rail 40 is fixed in a way that the heat is not transferred very much.

In this configuration, the cutter rail 40 is fixed to the paper delivery guide base 75 using the fixing portions 203. In this fixing method, the paper delivery guide base 75 is a thermal transfer path where heat is not transferred very much, since the heat of the paper delivery guide 71, which reaches high temperature due to the heat received from the fixing heater 90, is transferred via the fixing member 74 and the insulating material 76. The material used for the fixing member 74 is preferably a material of which thermal conductivity is lower than the materials used for the paper delivery guide 71 and the paper delivery guide base 75.

In the case of a configuration where the cutter rail 40 is fixed only to the paper delivery guide base 75, the strength of the fixing portions 203 depends on the strength of the plate thickness of the paper delivery guide base 75, and ensuring the strength may become difficult.

Therefore, in Embodiment 2 of the present disclosure, a reinforcing member 201 is installed below the paper delivery guide base 75, as illustrated in FIG. 10B, as a first configuration to ensure the strength mentioned above. Specifically, the reinforcing member 201 is installed in the paper delivery guide base 75 on the rear side of the part where the cutter rail 40 is fixed. The reinforcing member 201 includes a part that is installed in the paper delivery guide base 75 on the rear side of the portion where the fixing member 74 is fixed. The reinforcing member 201 is installed in the paper delivery guide base 75 so as to overlap with both the cutter rail 40 and the fixing member 74 when viewed in a direction VD vertical to the conveying surface of the paper delivery guide 71 (surface of the paper delivery guide 71 along the conveying direction CD of the sheet 1).

The reinforcing member 201 includes a mounting portion 201a, which is a mounting portion on the paper delivery guide base 75, and is an upstream side mounting portion in the conveying direction CD of the sheet 1. The mounting portion 201a is disposed near the fixing member 74, and in Embodiment 2, the mounting portion 201a is disposed at the upstream side of the fixing member 74 on the conveying path of the sheet 1. The portion near the fixing member 74 ensures the cross-sectional strength since the paper delivery guide 71 and the paper delivery guide base 75 are connected with the fixing member 74, hence the reinforcing member 201 can be firmly mounted.

The reinforcing member 201 also includes a mounting portion 201b, which is a mounting portion on the paper delivery guide base 75, and is a downstream side mounting portion in the conveying direction CD of the sheet 1. The mounting portion 201b is disposed at the downstream side of the fixing portions 203 of the cutter rail 40 and the paper delivery guide base 75 on the conveying path of the sheet 1.

By disposing this reinforcing member 201, the strength of the fixing portions 203 of the cutter rail 40 and the paper delivery guide base 75 can be firmer due to the plate thickness of the paper delivery guide base 75 and the reinforcing member 201. The paper delivery guide base 75 is constituted of a plate member (e.g., metal plate or the like), and by mounting the reinforcing member 201 as described above, deformation and the like can be prevented at least for the portion between the mounting portion 201a and the mounting portion 201b.

In the modification of Embodiment 2, as the second configuration to ensure strength, the downstream side end of the paper delivery guide 71 and the cutter rail 40 are fixed via the spacer member 202 having low thermal conductivity, as illustrated in FIG. 10C. The spacer member 202 is fixed to the cutter rail 40 by a fixing portion 204, and is fixed to the paper delivery guide 71 by a fixing portion 205. The spacer member 202 is disposed between the cutter rail 40 and the paper delivery guide 71 in the sheet conveying direction CD. The thermal conductivity of the material constituting the spacer member 202 is lower than the thermal conductivity of the material constituting the paper delivery guide 71.

According to this configuration, the cutter rail 40 is fixed to the paper delivery guide 71 via the paper delivery guide base 75 and the spacer member 202, hence the fixing strength can be ensured.

Configuration in the above embodiments may be combined with each other.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-210548, filed on Dec. 13, 2023, which is hereby incorporated by reference herein in its entirety.

What is claimed is:

1. A conveying device comprising:
a holding portion configured to hold a rolled sheet;
a conveying portion configured to convey a sheet drawn out of the rolled sheet held by the holding portion;
a guide portion configured to guide the sheet conveyed by the conveying portion; and
a cutting portion which is disposed in the guide portion to cut the sheet using a movable blade, wherein
the movable blade moves to a first position approaching the holding portion and to a second position departing from the holding portion.

2. The conveying device according to claim 1, further comprising a fixing portion configured to perform fixing processing on the sheet passing through a conveying path, wherein
the fixing portion is movable to a third position which faces the guide portion to heat the sheet, and to a fourth position departing from the guide portion.

3. The conveying device according to claim 2, wherein
the fixing portion includes a heater to heat the sheet passing through the conveying path as the fixing processing.

4. The conveying device according to claim 1, wherein
the guide portion further comprises:
a guide member configured to form a conveying surface of the sheet, and
a base member which is disposed on an opposite side of a conveying path with respect to the guide member, wherein
the cutting portion is disposed integrally with the base member.

5. The conveying device according to claim 4, wherein
the guide portion further comprises a fixing member configured to connect the guide member and the base member, wherein
thermal conductivity of a material constituting the fixing member is lower than thermal conductivity of a material constituting the base member.

6. The conveying device according to claim 5, wherein
the guide portion further comprises a heat insulating material which is filled between the guide member and the base member.

7. The conveying device according to claim 5, wherein
the cutting portion further comprises:
a rail which extends in a width direction of the sheet crossing with a conveying direction of the sheet; and
a cutting member configured to be movable on the rail in the width direction, wherein
the rail is fixed to the base member.

8. The conveying device according to claim 7, wherein
the cutting member includes an upper blade and a lower blade, which are disposed in a direction vertical to a surface of the sheet, wherein
the upper blade and the lower blade have a contact portion, and move on the rail in the width direction in a state of inserting the sheet in the contact portion, so that the sheet is cut by the contact portion.

9. The conveying device according to claim 5, further comprising a downstream guide portion configured to guide the sheet along the conveying path, at the downstream of the cutting portion on the conveying path, wherein
the downstream guide portion is disposed integrally with the guide portion and the cutting portion.

10. The conveying device according to claim 9, further comprising a winding portion which is disposed on the conveying path at the downstream of the downstream guide portion, and winds the sheet, wherein
the rolled sheet held by the holding portion is exposed between the guide portion at the second position, the cutting portion and the downstream guide portion; and the winding portion.

11. The conveying device according to claim 10, wherein
the downstream guide portion guides the sheet on the conveying path between the guide portion and the winding portion, while contacting the sheet so as to apply tensile force on the sheet.

12. The conveying device according to claim 11, wherein
the downstream guide portion has an R shape in a cross section vertical to a width direction of the sheet crossing a conveying direction of the sheet.

13. The conveying device according to claim 7, wherein
the guide portion further comprises a reinforcing member which is mounted on the base member on a rear side of a part to which the rail is fixed.

14. The conveying device according to claim 13, wherein
the reinforcing member includes a part which is mounted on the base member on a rear side of a portion to which the fixing member is fixed.

15. The conveying device according to claim 14, wherein
the reinforcing member overlaps with both the rail and the fixing member in a view in a direction vertical to the conveying surface.

16. The conveying device according to claim 14, wherein
the reinforcing member further comprises:
a downstream side mounting portion which is mounted on the base member on the conveying path at the downstream side of a fixing portion of the rail and the base member; and
an upstream side mounting portion which is mounted on the base member on the conveying path on an upstream side of the fixing member.

17. The conveying device according to claim 7, further comprising a spacer configured to connect the guide member and the rail, wherein
thermal conductivity of a material constituting the spacer is lower than thermal conductivity of a material constituting the guide member.

18. A recording apparatus comprising:
the conveying device according to claim 1; and
a recording portion configured to perform recording on a sheet on a conveying path between the holding portion and the guide portion.
